(19) United States
(12) Patent Application Publication
(10) Pub. No.: US 2026/0117601 A1
(43) Pub. Date: Apr. 30, 2026

(54) PREMIUM THREADED CONNECTIONS AND METHODS OF MAKING AND USING SAME

(71) Applicant: COMMAND TUBULAR PRODUCTS, LLC, NEW CANEY, TX (US)

(72) Inventors: MILTON HRUSCHAK, NISKU (CA); CHARLES GARVEY, SCOTTSDALE, AZ (US)

(73) Assignee: COMMAND TUBULAR PRODUCTS, LLC, NEW CANEY, TX (US)

(21) Appl. No.: 18/930,955

(22) Filed: Oct. 29, 2024

(51) Int. Cl. E21B 17/042

(52) U.S. Cl. CPC E21B 17/042

(57) ABSTRACT

Premium thread designs, premium threaded connections, and drill pipe having the premium threaded connections. Methods for making and assembling drill pipes with premium threaded connections.

### BACKGROUND INFORMATION

### Technical Field

The present disclosure relates generally to oil and gas tubulars. More particularly, the present disclosure relates to premium threading of oil and gas tubulars and processes of making and using same, in particular to drill pipes useful in drilling oil and gas wells, and drill pipes useful for drilling geothermal wells in the geothermal energy field.

### Background Art

In the field of earth rock drilling, completion, and servicing, for example to produce oil and/or gas or geothermal heat from a subterranean reservoir, the term “tubular” is often used to describe the various pipes. The Schlumberger® Oilfield Glossary at http://www.glossary.oilfield.slb.com describes “tubular” as a generic term pertaining to any type of oilfield pipe, such as drill pipe, drill collars, pup joints, casing, production tubing and pipeline. The related term “connection” is described as any threaded or nonthreaded union or joint that connects two tubular components. The present disclosure relates to threaded connectors/connections for tubulars.

A wide variety of threaded connections are available for tubulars, which may be general purpose connections or premium threaded connections, depending on the operating conditions.

As noted in U.S. Pat. Nos. 10,612,701 and 10,920,913 , one general purpose threaded connection is NC46, in accordance with American Petroleum Institute (API) 7-1, Specification for Rotary Drill Stem Elements and API 7-2, Specification for Threading and Gauging of Rotary Shouldered Thread Connections. A tubular/threaded connection meeting the NC46 standard will meet a number of technical specifications in terms of dimensions and operating parameters. General purpose, non-premium threaded tubulars and connections and have been around for years, but as wellbore operations have evolved, higher demands are placed tubulars and connections. Tubulars can be subjected to high temperatures and pressures and other extreme operating conditions, such as high torsional strength, for example in horizontal drilling or hydraulic fracturing operations, and often tubulars having premium threaded connections are required or preferred, such as the premium threaded pin and box connection known under the trade designation CET®43 as described in the '701 and '913 patents.

Although premium threaded connections are available, they continue to suffer from problems:

Unexpected failures—Premium connections can experience unexpected failures, such as coupling fractures and crevice corrosion.

Fretting fatigue—Fretting fatigue can occur at the middle of the thread root of premium threaded connections.

Copper (or other coating) flaking—metal coating on premium connections can oxidize and flake off, exposing the underlying steel or silver surface.

Joint-pull-out failure—Thread tapering can cause joint-pull-out failure, which reduces the tensile strength of the casing string.

Fatigue—Fatigue is a complex process that can affect mechanical components subjected to cyclic loads.

As may be seen, current practice may not be adequate for all circumstances, and at worst may result in premature drill string failure. There remains a need for more safe, robust premium threaded connections and methods for making and using the premium threaded connections for oil and gas and geothermal drilling. The premium threaded connections and methods of the present disclosure are directed to these needs.

### SUMMARY

In accordance with the present disclosure, premium threaded connectors and methods for making and using the premium threaded connectors for oil and gas and geothermal drilling are described which reduce or overcome many of the faults of previously known premium and non-premium threaded connections.

A first aspect of the present disclosure comprises (or consists essentially of, or consists of) converting relatively common tubulars having non-premium threaded connections, such as API connections, such as API Regular, API Internal Flush, API Full Hole, and API Numbered Connection (NC) connections, to higher value, high performance tubulars having premium connections, such as threads known under the trade designation CET®45 suitable for demanding applications such as horizontal drilling or hydraulic fracturing. Another aspect of the present disclosure is that premium threads known under the trade designation CET®45 provide distinct functional advantages over other threads. Threads known under the trade designation CET®45 may be applied to new tubulars, used tubulars, or may be freshly cut into metal blanks to be used with tubulars.

In certain embodiments in accordance with the present disclosure, the threads disclosed herein known under the trade designation CET®45 may be applied to an integral connection (for example pin-box) or a threaded and coupled connection (for example pin-coupling-pin, as in oil country tubular goods (OCTG)). The threads disclosed herein may be applied to a new tubular or a recycled or re-used or repurposed tubular as described herein.

In methods in accordance with the first aspect, the present disclosure provides methods comprising (or consisting essentially of, or consisting of):
a) providing a tubular having a non-premium threaded box connection and a non-premium threaded pin connection;
b) reducing a box outer diameter of the non-premium threaded box connection and enlarging a box inner diameter of the non-premium threaded box connection to provide a prepared box connection;
c) applying a box premium thread to the prepared box connection;
d) reducing a pin outer diameter of the non-premium threaded pin connection and enlarging a pin inner diameter of the non-premium threaded pin connection to provide a prepared pin connection; and
e) applying a pin premium thread to the prepared pin connection, wherein the tubular is provided with a premium box connection and a premium pin connection.

In certain embodiments in accordance with present disclosure, the premium box thread comprises a premium box thread known under the trade designation CET®45, wherein the premium pin thread comprises a premium pin thread known under the trade designation CET®45, and wherein the box premium connection and the pin premium connections are connections known under the trade designation CET®45, wherein the premium threaded connection known under the trade designation CET®45 has dimensions as described herein.

In certain embodiments in accordance with the present disclosure, the methods may further include heating a hardband portion of the non-premium box connection to about 900, or to about 925, or to about 950 degrees Fahrenheit prior to reducing the outer diameter.

In certain embodiments in accordance with the present disclosure, the methods may further include phosphating the connections known under the trade designation CET®45.

In certain embodiments in accordance with the present disclosure, the methods may further include applying a make and break process to the connections known under the trade designation CET®45.

In certain embodiments in accordance with the present disclosure, the connections known under the trade designation CET®45 may have an outer diameter of about 5.875 inches, and an inner diameter of about 3.25 inches.

In certain embodiments in accordance with the present disclosure, the box threads known under the trade designation CET®45 may have a pitch of about 0.25 inch (4 TPI), a pitch diameter of about 4.896 inches, an angle of about 60 degrees, a crest to root height of about 0.092500 inch, a taper of about 1.5 in/ft., a crest width of about 0.076 inch, and a root width of about 0.067 inch (where the crest is actually pointing down in FIG. 25, and the root is pointing up).

In certain embodiments in accordance with the present disclosure, the pin threads known under the trade designation CET®45 may have a pitch of about 0.25 inch (4 TPI), an angle of about 60 degrees, a crest to root height of about 0.092504 inch, a taper of about 1.5 in/ft, a crest width of about 0.076 inch, and a root width of about 0.067 inch (where the crest is pointing up in FIG. 22, and the root is pointing down).

In certain embodiments in accordance with the present disclosure, the tubular may be previously used or reconditioned.

In certain embodiments in accordance with the present disclosure, the methods may further include performing a wellbore operation using the tubular having connections known under the trade designation CET®45.

In certain embodiments in accordance with the present disclosure, the wellbore operation may comprise a drilling operation, such as vertical drilling, horizontal drilling, deviated drilling, onshore drilling, offshore drilling, and geothermal drilling. In certain embodiments in accordance with the present disclosure, the wellbore operation may comprise a fracturing operation.

In a second aspect, the present disclosure provides methods of converting a tubular having API connections to premium connections known under the trade designation CET®45, comprising (or consisting essentially of, or consisting of):
a) providing the tubular, having an API box connection and an API pin connection;
b) heating a hardband portion of the API box connection to about 950 degrees Fahrenheit and reducing a box outer diameter of the API box connection;
c) enlarging a box inner diameter of the API box connection, wherein a prepared box connection is provided;
d) applying a box thread to the prepared box connection, wherein the box threads have a pitch of about 0.25 inch (4 TPI), a pitch diameter of about 4.896 inches, an angle of about 60 degrees, a crest to root height of about 0.092500 inch, a taper of about 1.5 in/ft., a crest width of about 0.076 inch, and a root width of about 0.067 inch, a box outer face bevel having bevel diameter of about 5.575 inches (plus or minus 0.016 inch), a face bearing surface having a counterbore diameter of 5.067 inches (plus or minus 0.010 inch); and a box shoulder bearing surface having diameter of about 4.423 inches (plus or minus 0.010 inch);
e) reducing a pin outer diameter of the API pin connection;
f) enlarging an inner diameter of the API pin connection, wherein a prepared pin connection is provided; and
g) applying a pin thread to the prepared pin connection, wherein the pin threads have a pitch of about 0.25 inch (4 TPI), an angle of about 60 degrees, a crest to root height of about 0.092504 inch, a taper of about 1.5 in/ft., a crest width of about 0.076 inch, and a root width of about 0.067 inch, an outer pin shoulder bevel having bevel diameter of about 5.575 inches (plus or minus 0.016 inch), a pin shoulder bearing surface having cylinder diameter of about 4.972 inches (plus or minus 0.010 inch), and a nose bearing surface having a diameter of about 4.326 inches (plus or minus 0.010 inch).

In a further aspect, the present disclosure provides methods to recut tubulars having threaded connections known under the trade designation CET®45, comprising (or consisting essentially of, or consisting of):
a) providing a tubular having premium threaded connections known under the trade designation CET®45; and
b) re-cutting the premium threaded connections known under the trade designation CET®45, wherein a remaining tong length exceeds a predetermined minimum tong length after re-cutting;
   the premium threaded connections known under the trade designation CET®45 comprising:
c) a box thread having a pitch of about 0.25 inch (4 TPI), a pitch diameter of about 4.896 inches, an angle of about 60 degrees, a crest to root height of about 0.092500 inch, a taper of about 1.5 in/ft., a crest width of about 0.076 inch, and a root width of about 0.067 inch, a box outer face bevel having bevel diameter of about 5.575 inches (plus or minus 0.016 inch), a face bearing surface having a counterbore diameter of 5.067 inches (plus or minus 0.010 inch); and a box shoulder bearing surface having diameter of about 4.423 inches (plus or minus 0.010 inch); and
d) a pin thread having a pitch of about 0.25 inch (4 TPI), an angle of about 60 degrees, a crest to root height of about 0.092504 inch, a taper of about 1.5 in/ft., a crest width of about 0.076 inch, and a root width of about 0.067 inch, an outer pin shoulder bevel having bevel diameter of about 5.575 inches (plus or minus 0.016 inch), a pin shoulder bearing surface having cylinder diameter of about 4.972 inches (plus or minus 0.010 inch), and a nose bearing surface having a diameter of about 4.326 inches (plus or minus 0.010 inch).

In a further aspect, the present disclosure provides a box connection known under the trade designation CET®45 for a first tubular, comprising (or consisting essentially of, or consisting of):
a) a box shoulder stop;
b) a box shoulder bearing surface;
c) a face bearing surface;
d) a face stop;
e) an outer face bevel;
f) box threads extending between the face bearing surface and the box shoulder bearing surface;
g) the threaded box connection adapted to mate with a corresponding threaded pin connection of a second tubular, the box shoulder bearing surface adapted to retain a corresponding nose bearing surface of the threaded pin connection;
h) the box threads are tapered threads having a pitch of about 0.25 inch (4 TPI), a pitch diameter of about 4.896 inches, an angle of about 60 degrees, a crest to root height of about 0.092500 inch, a taper of about 1.5 in/ft., a crest width of about 0.076 inch, a root width of about 0.067 inch, and conform to thread gauge V-0.076 thread form design data;
i) the outer face bevel having bevel diameter of about 5.575 inches (plus or minus 0.016 inch);
j) the face bearing surface having a counterbore diameter of 5.067 inches (plus or minus 0.010 inch); and
k) the box shoulder bearing surface having diameter of about 4.423 inches (plus or minus 0.010 inch).

In certain embodiments in accordance with the present disclosure, the face bearing surface may be adapted to retain a corresponding pin shoulder bearing surface of the pin connection known under the trade designation CET®45.

In certain embodiments in accordance with the present disclosure, the face stop and the pin shoulder stop may be adapted to abut, the nose and the box shoulder stop may be adapted to abut, or both.

In certain embodiments in accordance with the present disclosure, an annular space between the box shoulder bearing surface and the nose bearing surface defines a first bearing gap.

In certain embodiments in accordance with the present disclosure, an annular space between the tail bearing surface and the face bearing surface defines a second bearing gap.

In certain embodiments in accordance with the present disclosure, the first bearing gap or the second bearing gap or both may be in the range of about 0.01 inch to about 0.10 inch. In certain embodiments disclosed herein, the first bearing gap or the second bearing gap or both may be about 0.020 inch.

In a further aspect, the present disclosure provides a pin connection known under the trade designation CET®45 for a first tubular, comprising (or consisting essentially of, or consisting of):
a) a nose;
b) a nose bearing surface;
c) a pin shoulder bearing surface;
d) a pin shoulder stop;
e) an outer pin shoulder bevel;
f) pin threads extending between the nose bearing surface and the pin shoulder bearing surface;
g) the threaded pin connection adapted to mate with a corresponding threaded box connection of a second tubular, wherein the nose bearing surface is adapted to be retained by a mating box shoulder bearing surface of the threaded box connection;
h) the pin threads are tapered threads having a pitch of about 0.25 inch (4 TPI), an angle of about 60 degrees, a crest to root height of about 0.092504 inch, a taper of about 1.5 in/ft., a crest width of about 0.076 inch, and a root width of about 0.067 inch, and conform to thread gauge V-0.076 thread form design data;
i) the outer pin shoulder bevel having bevel diameter of about 5.575 inches (plus or minus 0.016 inch);
j) the pin shoulder bearing surface having cylinder diameter of about 4.972 inches (plus or minus 0.010 inch); and
k) the nose bearing surface having a diameter of about 4.326 inches (plus or minus 0.010 inch).

In certain embodiments in accordance with the present disclosure, the pin shoulder bearing surface may be adapted to be retained by a mating face bearing surface of the box connection known under the trade designation CET®45.

In certain embodiments in accordance with the present disclosure, the face stop and the pin shoulder stop may be adapted to abut, the nose and the box shoulder stop may be adapted to abut, or both.

In certain embodiments in accordance with the present disclosure, an annular space between the box shoulder bearing surface and the nose bearing surface defines a first bearing gap.

In certain embodiments in accordance with the present disclosure, an annular space between the tail bearing surface and the face bearing surface defines a second bearing gap.

In certain embodiments in accordance with the present disclosure, the first bearing gap or the second bearing gap or both may be in the range of about 0.01 inch to about 0.10 inch. In an embodiment disclosed, the first bearing gap or the second bearing gap or both may be about 0.020 inch.

In a further aspect, the present disclosure provides a tubular having connections known under the trade designation CET®45, comprising (or consisting essentially of, or consisting of) a box connection known under the trade designation CET®45 and a pin connection known under the trade designation CET®45.

Another aspect of the present disclosure are drill strings comprising one or more of the threaded connections of this disclosure. Yet another aspect of the present disclosure are drilling risers incorporating one or more threaded connections of the present disclosure therein. As used herein “drilling riser” means a standard drilling riser or riser joint, either a low-pressure drilling riser joint or a high-pressure drilling riser joint.

In certain embodiments the threaded connections described in accordance with the present disclosure may have a burst pressure exceeding an anticipated standpipe pressure of a drilling rig. In certain embodiments the threaded connections may have a tensile strength equal to or greater than a tensile strength of the drill pipe in the event of overpull is required to free the drill string during a stuck situation. In certain embodiments the threads or portions thereof may have a coating to mitigate corrosion from drilling fluids and other downhole fluids. In certain embodiments the threads may comprise a corrosion-resistant material.

In certain embodiments the threaded sections may comprise a modified buttress/ACME thread comprising a trapezoidal channel shape having a weight bearing surface making an angle ranging from about 5 to about 10 degrees with vertical, and a trailing flank making an angle ranging from about 40 to about 50 degrees with vertical.

In certain embodiments the drill pipe may be configured to contain pressure ranging from about 500 psi to about 15,000 psi.

In certain embodiments premium threaded connections known under the trade designation CET®45 may have a makeup torque of at least 42,800 ft-lbs. (the recommended MUT for 130 ksi tool joints).

In certain embodiments the drill pipe may have a tensile strength of 130 ksi or greater. In certain embodiments, the drill pipe may have a bore size of 4.17 inches or greater, box and pin outer diameters of 5.875 inches or greater, and upset end outer diameters of 5 inches or greater.

These and other features of the premium thread designs, pin and box connections and couplers employing same, and processes of the present disclosure will become more apparent upon review of the brief description of the drawings, the detailed description, and the claims that follow. It should be understood that wherever the term “comprising” is used herein, other embodiments where the term “comprising” is substituted with “consisting essentially of” are explicitly disclosed herein. It should be further understood that wherever the term “comprising” is used herein, other embodiments where the term “comprising” is substituted with “consisting of” are explicitly disclosed herein. Moreover, the use of negative limitations is specifically contemplated; for example, certain premium thread designs may be devoid of chemical treatment, such as phosphating. As another example, certain threaded connections may be devoid of hardband areas.

### BRIEF DESCRIPTION OF THE DRAWINGS

The manner in which the objectives of this disclosure and other desirable characteristics can be obtained is explained in the following description and attached drawings in which:

FIG. 1 is a schematic side-elevation view of a portion of tubulars having API pin connections and API box connections;

FIG. 2 is a schematic side-elevation view of a portion of a tubular having an API pin connection, with a portion of hardbanding removed;

FIG. 3 is a schematic perspective view of the API pin connection illustrated schematically in FIG. 2, with the hardbanding removed and an identification groove applied;

FIG. 4 is a schematic end view of the API pin connection illustrated schematically in FIG. 3, before the inner diameter is enlarged;

FIG. 5 is a schematic end view of the API pin connection illustrated schematically in FIG. 4, after the inner diameter has been enlarged;

FIG. 6 is a schematic perspective view of the API pin connection illustrated schematically in FIG. 5, having a prepared pin connection, before threading;

FIG. 7 is a schematic perspective view of the API pin connection illustrated schematically in FIG. 6, with the API pin connection converted to a pin connection known under the trade designation CET®45;

FIG. 8 is a schematic longitudinal cross-sectional view illustrating a pin connection known under the trade designation CET®45;

FIG. 9 is a schematic detail view of a portion of the pin connection known under the trade designation CET®45 illustrated schematically in FIG. 8;

FIG. 10 is a schematic detail view of a portion of the threads of the pin connection known under the trade designation CET®45 illustrated schematically in FIG. 8;

FIG. 11 is a schematic perspective view of a portion of a tubular having an API box connection;

FIG. 12 is a schematic perspective view of the API box connection illustrated schematically in FIG. 11, being heated;

FIG. 13 is a schematic end view of the API box connection illustrated schematically in FIG. 12, after the hardbanding has been removed and the outer diameter has been reduced;

FIG. 14 is a schematic end view of the API box connection illustrated schematically in FIG. 13, with the API box connection converted to a box connection known under the trade designation CET®45;

FIG. 15 is a schematic longitudinal cross-sectional view illustrating a box connection known under the trade designation CET®45;

FIG. 16 is a schematic detail view of a portion of the box connection known under the trade designation CET®45 illustrated schematically in FIG. 15;

FIG. 17 is a schematic detail view of a portion of the threads of the box connection known under the trade designation CET®45 illustrated schematically in FIG. 15;

FIG. 18A is a schematic longitudinal cross-sectional view illustrating the pin connection known under the trade designation CET®45 illustrated schematically in FIGS. 8-10, and FIG. 18B is a schematic longitudinal cross-sectional view illustrating the box connection known under the trade designation CET®45 illustrated schematically in FIGS. 15-17, aligned for connection;

FIG. 19 is a schematic longitudinal cross-sectional view illustrating the pin connection illustrated schematically in FIG. 18A, and a schematic longitudinal cross-sectional view illustrating the box connection illustrated schematically in FIG. 18B, threadedly connected;

FIG. 20 is a schematic, detailed longitudinal cross-sectional view illustrating the pin connection known under the trade designation CET®45 illustrated schematically in FIGS. 8-10, and FIGS. 21 and 22 are schematic detailed views of portions of the pin connection known under the trade designation CET®45 illustrated schematically in FIG. 20;

FIG. 23 is a schematic, detailed longitudinal cross-sectional view illustrating the box connection known under the trade designation CET®45 illustrated schematically in FIGS. 15-17, and FIGS. 24 and 25 are schematic detailed views of portions of the box connection known under the trade designation CET®45 illustrated schematically in FIG. 23; and

FIG. 26 is a logic diagram illustrating one method embodiment in accordance with the present disclosure.

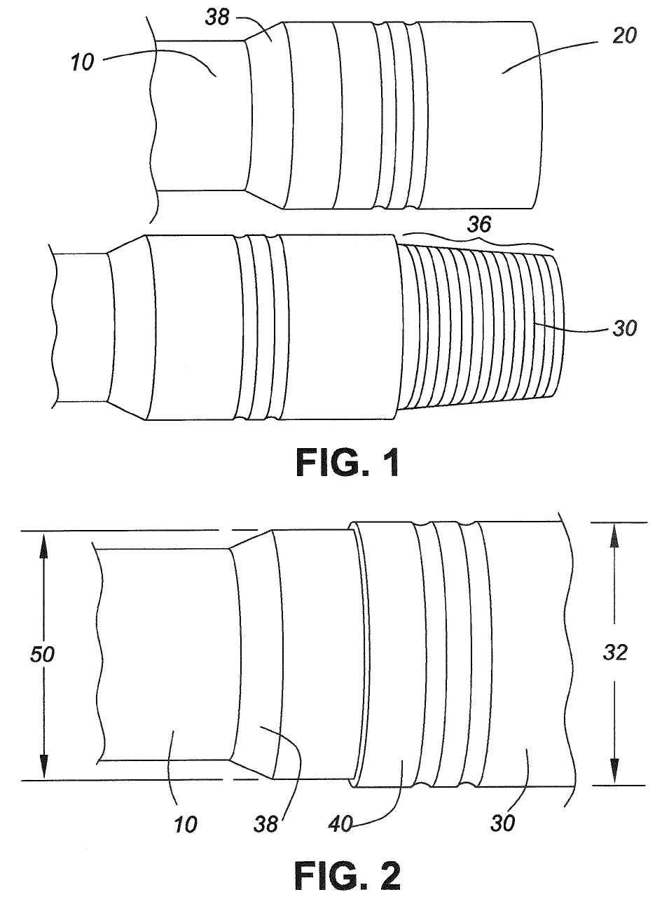

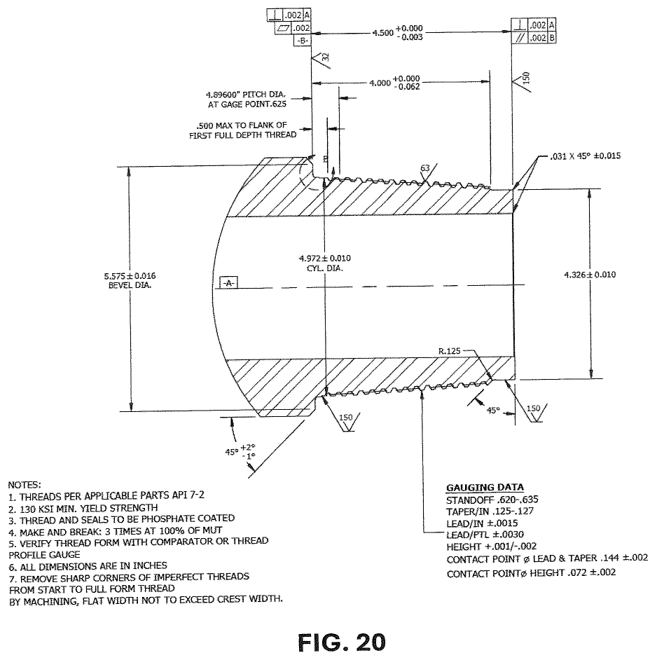

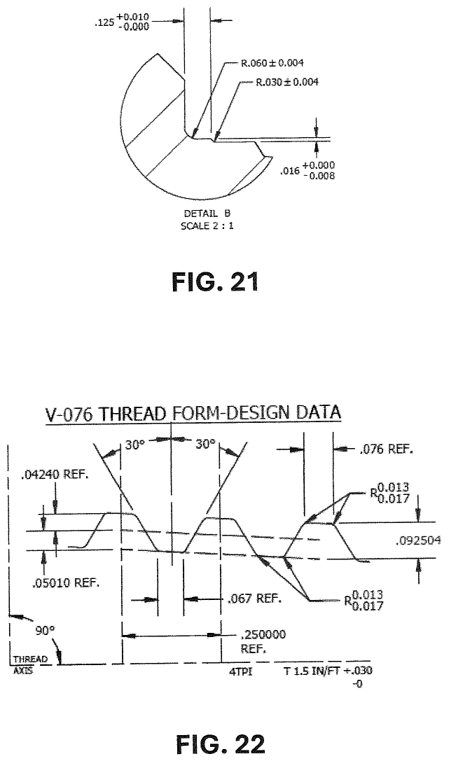

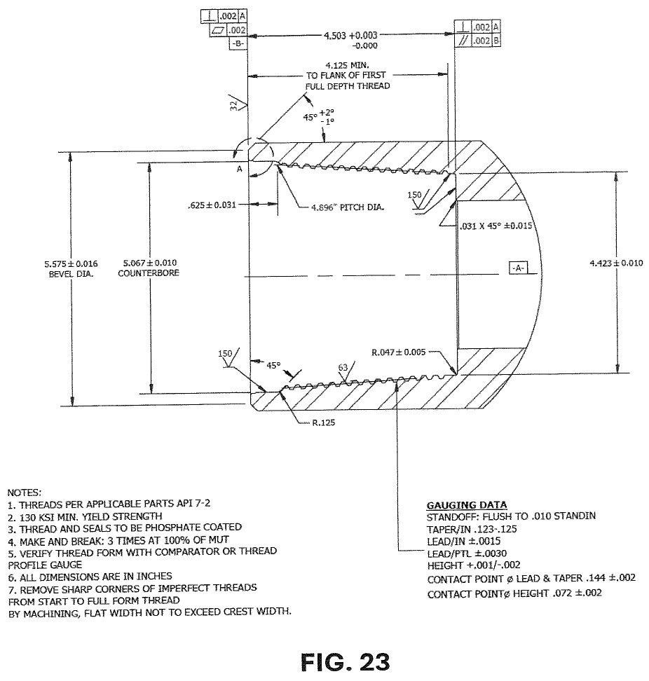

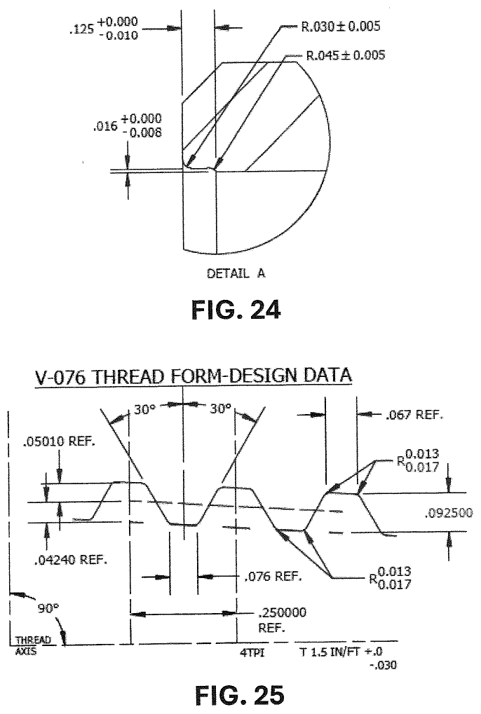

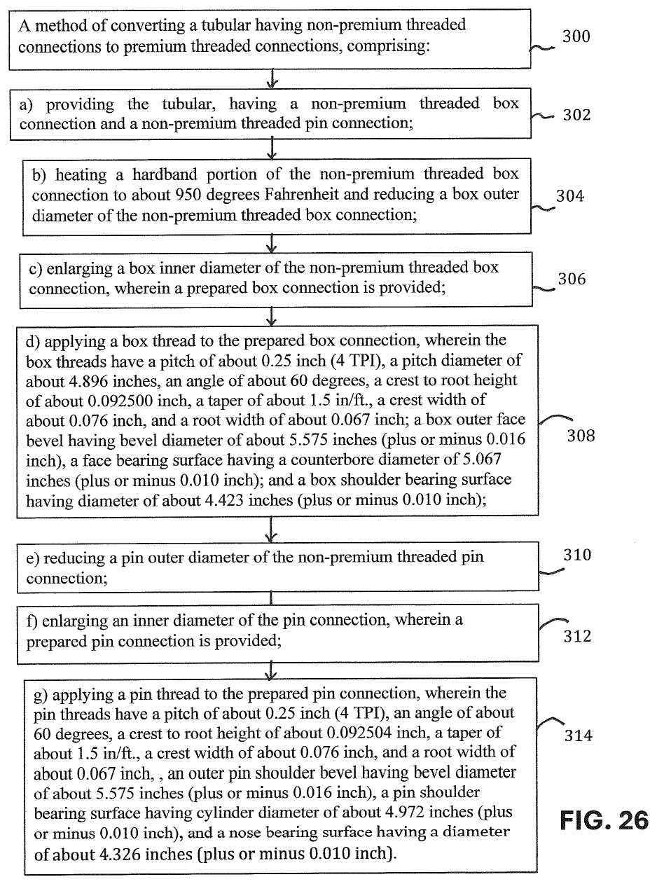

It is to be noted, however, that the appended drawings of FIGS. 1-25 are not to scale and illustrate only typical non-premium and premium thread designs and other features of this disclosure. Furthermore, FIG. 26 illustrates only one of many possible methods of this disclosure. Therefore, the drawing figures are not to be considered limiting in scope, for the disclosure may admit to other equally effective embodiments. Identical reference numerals are used throughout the several views for like or similar elements.

### DETAILED DESCRIPTION

In the following description, numerous details are set forth to provide an understanding of the disclosed apparatus, combinations, and processes. However, it will be understood by those skilled in the art that the apparatus and processes disclosed herein may be practiced without these details and that numerous variations or modifications from the described embodiments may be possible. All technical articles, published and non-published patent applications, standards, patents, statutes and regulations referenced herein are hereby explicitly incorporated herein by reference, irrespective of the page, paragraph, or section in which they are referenced. All percentages herein are by weight unless otherwise noted. Where a range of values describes a parameter, all sub-ranges, point values and endpoints within that range are explicitly disclosed herein. This document follows the well-established principle that the words “a” and “an” mean “one or more” unless we evince a clear intent to limit “a” or “an” to “one.” For example, when we state “flowing a fluid through a tubing positioned inside a casing of a well”, we mean that the specification supports a legal construction of “a tubing” that encompasses structure distributed among multiple physical structures, and a legal construction of “a well” that encompasses structure distributed among multiple physical structures. As used herein, “API” refers to American Petroleum Institute, Washington, D.C. As used herein, “NACE” refers to the corrosion prevention organization formerly known as the National Association of Corrosion Engineers, now operating under the name NACE International, Houston, Texas. “psi” refers to pounds per square inch; “ksi” refers to thousand pounds per square inch; “MPa” refers to megapascals; “GPa” refers to gigapascals, all of which are units of pressure.

In the following detailed description of the drawing figures, the labels “first”, “second”, “top”, “bottom, ”upper“, ”lower“, left”, “right”, “horizontal”, “vertical” are merely convenient terminology to assist the reader, and are examples only, intended to describe threaded connections and drill pipes, drill collars, and the like positioned vertically in a well bore. There is for example no reason the “first” and “second” features or the “left”and “right”features could not be reversed.

As mentioned herein, known premium threaded connections may not be adequate for all circumstances, and at worst may result in premature drill string failure. There remains a need for more safe, robust premium threaded connections and methods for making and using the premium threaded connections for oil and gas and geothermal drilling, fracturing, and other operations. The premium threaded connections and methods of the present disclosure are directed to these needs.

As further explained herein the present disclosure describes converting relatively common tubulars having API or other non-premium threaded connections to higher value, high performance tubulars having premium connections, such as threads known under the trade designation CET®45 suitable for demanding applications such as drilling or hydraulic fracturing. Another aspect of the present disclosure is that threads known under the trade designation CET®45 provide distinct functional advantages over other threads. Threads known under the trade designation CET®45 may be applied to new tubulars, used tubulars, or may be freshly cut into metal blanks to be used with tubulars.

Generally, the present disclosure provides a method and system for providing a tubular having connections known under the trade designation CET®45, and in a particular embodiment, converting a tubular from API connections to connections known under the trade designation CET®45.

Referring to FIG. 1, a receiving inspector inspects a tubular 10 and any identification marks, such as work order numbers, serial numbers, purchase order numbers, or anything stenciled or stamped onto the tubular 10. Serial numbers are recorded and written back on tubular 10 on both sides. Tubular 10 may have an API box connection 20, an API pin connection 30, or both.

In certain embodiments in accordance with the present disclosure, the materials must be within a specified yield strength, for example 130 ksi minimum.

In certain embodiments in accordance with the present disclosure, “API connection” refers to API 7-1, Specification for Rotary Drill Stem Elements, and API 7-2, Specification for Threading and Gauging of Rotary Shouldered Thread Connections, or other applicable specification, and specifically API Numbered Connection, for example NC46 having 4 threads per inch (TPI), 2 inch taper per foot (TPF), and thread gauge V-0.038R.

Tubular 10 is loaded onto an inbound rack where the process of converting the tubular from API connections to connections known under the trade designation CET®45 begins.

### Pin Connection

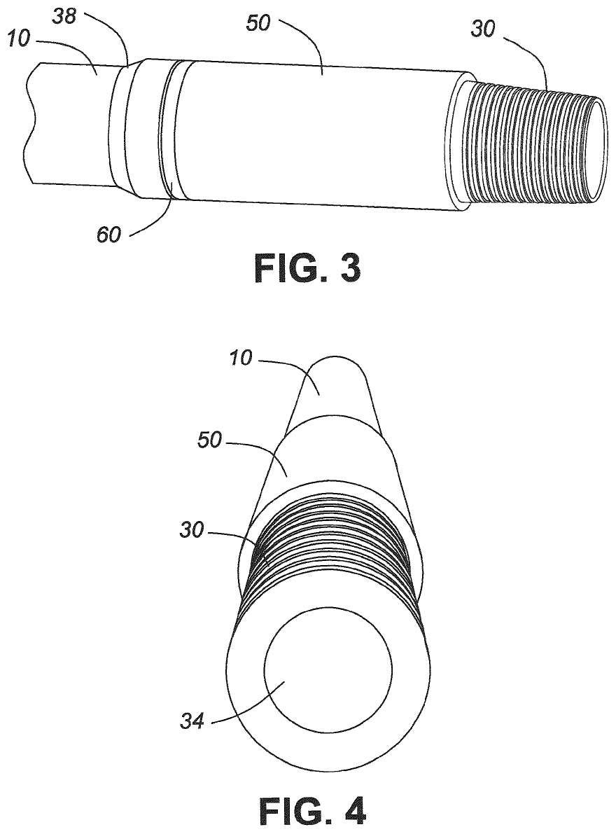

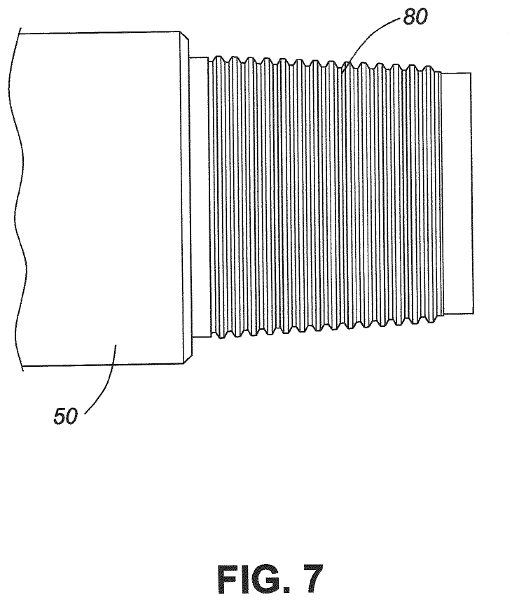

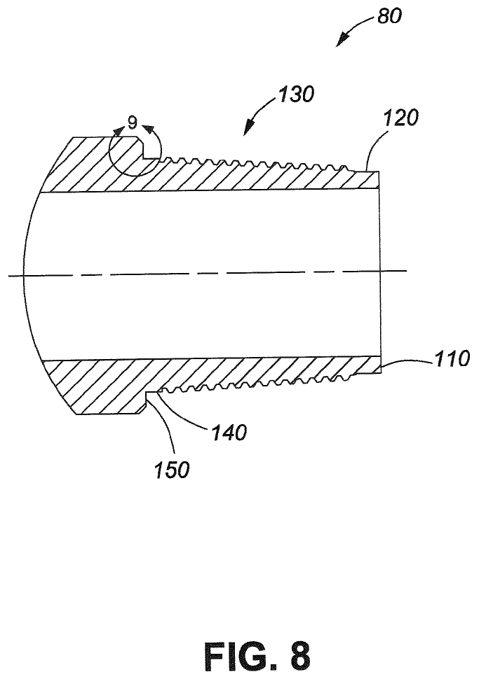

Referring to FIG. 2, any hardbanding 40 is removed (API pin connection 30 shown), for example by computer numeric control (CNC) lathe or machining tool, as described in the '701 and '913 patents. The length 36 (see FIG. 1) may be checked. An outer diameter 32 of the API pin connection is machined to provide a reduced outer diameter 50 (hardbanding 40 shown only partially removed). The particular example tubular 10 shown, calls for a pin connection known under the trade designation CET®45 (illustrated at 80 in FIGS. 7 and 8) having a 5.37 inch outer diameter.

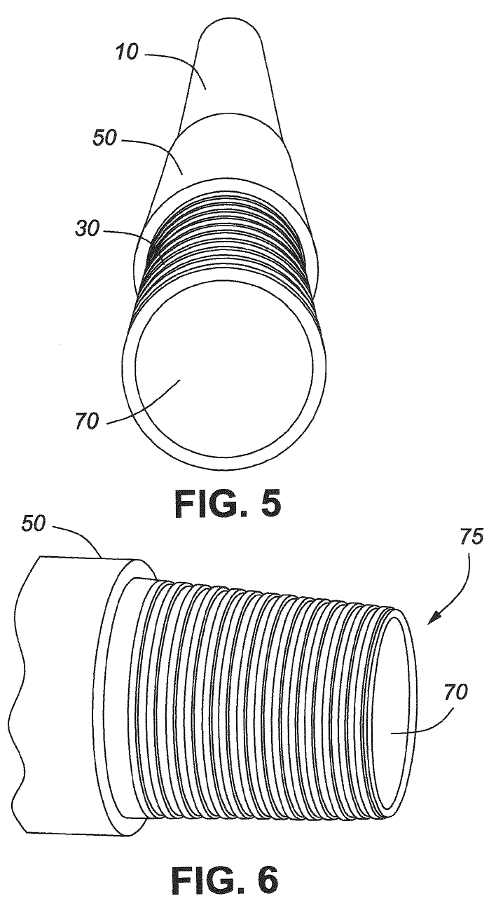

Referring to FIG. 3, outer diameter 32 of API pin connection 30 has been machined to provide reduced outer diameter 50 (for example 5.375 inches), and an identification groove 60 is provided (for example, machined) at a predetermined location from taper 38 (for example 2 inches from an 18 degree taper as illustrated schematically). The machine operator then inspects identification groove 60 to confirm compliance with print specifications (normally 0.0625 inch deep).

Referring to FIG. 4, once reduced outer diameter 50 has been reduced, for example by machining, the API pin connection 30 has an inner diameter of 3.25 inches or less and must be enlarged or bored out to 3.25 inch diameter to meet the requirements of a pin connection known under the trade designation CET®45 (illustrated at 80 in FIGS. 7 and 8). The tubulars may initially have any inner diameter ranging from 2 inches to 3.25 inches before they are converted to pin connections known under the trade designation CET®45.

Referring to FIG. 5, the inner diameter 34 of pin connection 30 is enlarged to provide an enlarged inner diameter 70 to meet print specifications. A drift may be used to check compliance.

Referring to FIG. 6, once reduced outer diameter 50 and enlarged inner diameter 70 are complete, the machine operator may ensure reduced outer diameter 50 and enlarged inner diameter 70 are concentric, and prepared pin connection 75 is ready for the threading process. Pin connection 30 is prepared and is ready for threads known under the trade designation CET®45 threads to be applied. A face off tool is used for the first cut. A rough profile cut is made to cut the profile to print specifications. Threads are then cut. The machine operator inspects, using a ring gage for the threads known under the trade designation CET®45, that the threads are machined to print specifications.

Referring to FIG. 7, prepared pin connection 75 has been threaded with threads known under the trade designation CET®45 to provide a pin connection 80 having threads known under the trade designation CET®45. Pin thread protectors (not illustrated) may be applied.

### Pin Connection

Referring to FIGS. 7-10, and 18-19, a pin connection 80 having threads known under the trade designation CET®45 is illustrated, of a specific size. However, threads known under the trade designation CET®45 may be applied in different sizes.

The threads known under the trade designation CET®45 provide high torque, high threads per inch (TPI), and reduced shoulder and nose length.

The threads known under the trade designation CET®45 threads may be applied to a wide variety of tubular/pipe sizes, including but not limited to 4½-inch, 5-inch, 5½-inch, 6⅝-inch, and 7⅝-inch pipe outer diameter.

In certain embodiments, the connection known under the trade designation CET®45 has an outer diameter of 5.875 inches, an inner diameter of 3.25 inches, a recommended make-up torque of 42,800 ft-lbs., a tensile yield strength of 951,000 lbs., and a torsional yield strength of 65,900 ft-lbs.

Referring to FIG. 8, pin connection 80 known under the trade designation CET®45 has a nose bearing surface 120 of relatively short length, tapered thread 130, and a pin shoulder bearing surface 140 of relatively short length. In certain embodiments, the length of nose bearing surface 120 is about 0.5 inch. In certain embodiments, the length of pin shoulder bearing surface 140 is about 0.5 inch or less (measured from the pin shoulder stop 150 to the flank of the first full depth thread). In certain embodiments, the distance between nose 110 and pin shoulder stop 150 is about 4.5 inches. In certain embodiments, the diameter of nose bearing surface 120 is about 4.326 inches (plus or minus 0.010 inch). In certain embodiments, the diameter of pin shoulder bearing surface 140 is about 4.972 inches (plus or minus 0.010 inch).

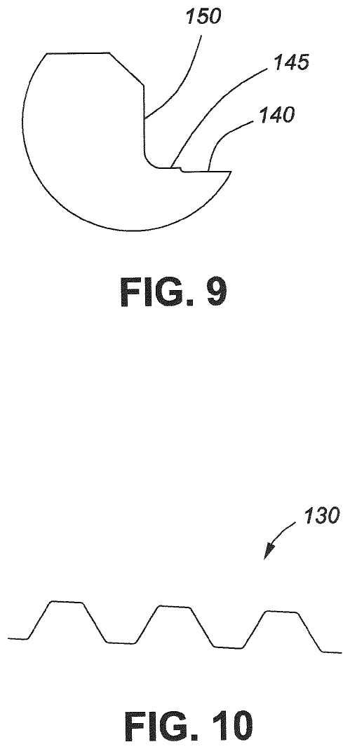

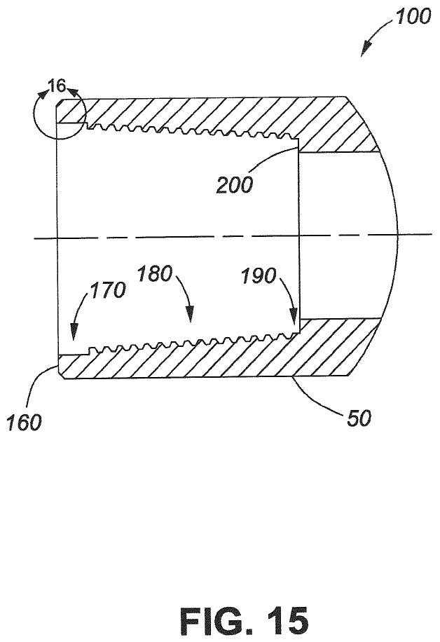

Referring to FIG. 9, in the embodiment illustrated schematically, pin shoulder bearing surface 140 includes a reduced clearance portion 145 adapted to form a tight fit with the mating face bearing surface 170 of the mating box connection 100 known under the trade designation CET®45 (see FIG. 15). In the embodiment illustrated schematically, the tight fit is an interference fit, and reduced clearance portion 145 has a length of about 0.125 inch.

Referring to FIG. 10, in the embodiment illustrated schematically, the tapered threads 130 have a pitch of about 0.25 inch (4 TPI), an angle of about 60 degrees, a crest to root height of about 0.092504 inch, a taper of about 1.5 in/ft., a crest width of about 0.076 inch, and a root width of about 0.067 inch, and tapered threads 130 conform to thread gauge V-0.076 thread form design data.

### Box Connection

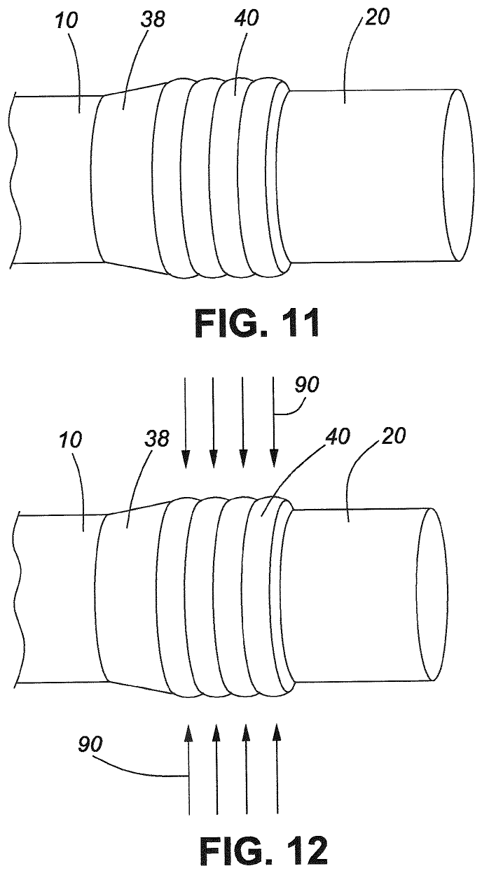

Referring to FIG. 11, a receiving inspector inspects the outer diameter 22, inner diameter 24, hardbanding 40, and identification marks (if any) of tubular 10. The length 26 of the threads may be checked. The tubular 10 has at least one API box connection 20.

Tubular 10 is loaded onto an inbound rack where the process of converting tubular 10 from API connections to connections known under the trade designation CET®45 begins.

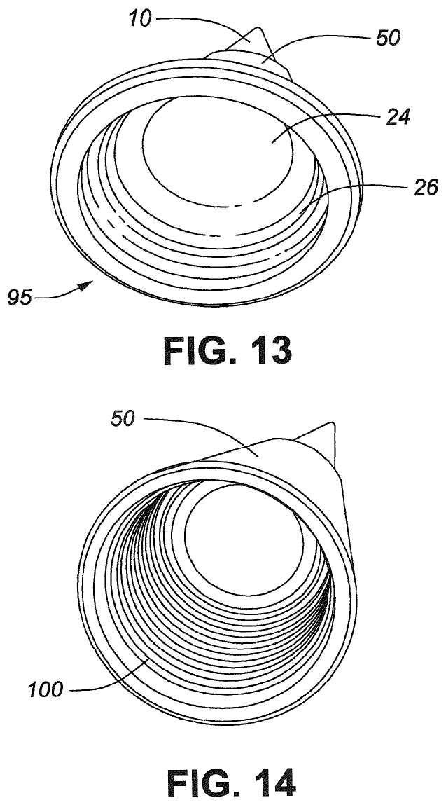

Referring to FIG. 12, the hardbanding 40, if any, is heated to about 950 degrees Fahrenheit by applying heat 90. This process is only necessary on the box end, as the hardbanding 40 is longer (three 1-inch bands on the box end as opposed to two 1-inch bands on the pin end). The CNC machine provides a reduced outer diameter 50 (FIGS. 13 and 14). This particular example box connection 100 known under the trade designation CET®45 calls for a 5.875 inches outer diameter.

Referring to FIGS. 13-15, the machine operator visually inspects inner diameter 24 on the box end connection to verify reduced outer diameter 50 meets the print specifications, to provide a prepared box connection 95.

The machine operator inspects the tapered threads 180, using a plug gage suitable for connections known under the trade designation CET®45, to ensure that threads 180 are machined to print specifications. Box threads known under the trade designation CET®45 have a thread protector applied and pipe or tubular 10 is ready for the next step.

Referring to FIGS. 13-15, threads known under the trade designation CET®45 have been applied to prepared box connection 95 and box connection 100 having threads known under the trade designation CET®45 is provided.

### Box Connection Threads

Referring to FIGS. 14-19, box connection 100 having threads known under the trade designation CET®45 is illustrated schematically, of a specific size. However, threads known under the trade designation CET®45 may be applied to different sizes.

In the embodiment illustrated, the threads known under the trade designation CET®45 provide 5¼ turns to make-up, have 120 to 170 percent of the torsional strength of API connections (for example, CET®45 vs. NC46 is 150 percent; CET®45 vs. NC50 is 130 percent) and may be applied to various tubulars, including drill pipe, heavy-weight drill pipe and collars for use on work strings, slimhole drillstrings and frac strings.

The threads known under the trade designation CET®45 provide high torque, high threads per inch (TPI), and reduced shoulder and nose length.

The threads known under the trade designation CET®45 may be applied to a wide variety of pipe sizes, including but not limited to 4½-inch, 5-inch, 5½-inch, 6⅝-inch, and 7⅝-inch pipe outer diameter.

Referring to FIG. 15, in the embodiment illustrated schematically, the box connection 100 known under the trade designation CET®45 extends between a face stop 160 and a box shoulder stop 200, and includes a face bearing surface 170, tapered thread 180, and a box shoulder bearing surface 190. In the embodiment illustrated schematically, face bearing surface 170 is about 0.625 inch wide; box shoulder bearing surface 190 is about 0.375 inch wide; the distance from face stop 160 to the flank of the first full depth thread (proximate box shoulder stop 200) is about 4.125 inches or more; the distance from face stop 160 to box shoulder stop 200 is about 4.5 inches; reduced outer diameter 50 is about 5.575 inches (plus or minus 0.016 inch); counterbore/face bearing surface 170 has a diameter of about 5.067 inches (plus or minus 0.010 inch); and box shoulder bearing surface 190 has a diameter of about 4.423 inches (plus or minus 0.010 inch).

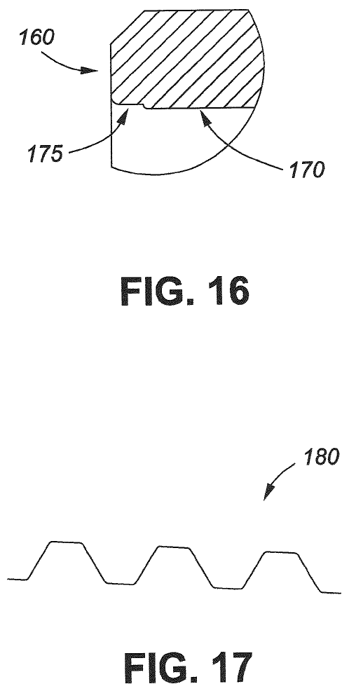

Referring to FIG. 16, in the embodiment illustrated schematically, box connection 100 includes an enlarged guide portion 175 between face stop 160 and face bearing surface 170. Enlarged guide portion 175 is about 0.125 inch wide in the illustrated embodiment.

Referring to FIG. 17, in the embodiment illustrated schematically, tapered threads 180 have a pitch of about 0.25 inch (4 TPI), a pitch diameter of about 4.896 inches, an angle of about 60 degrees, a crest to root height of about 0.092500 inch, a taper of about 1.5 in/ft., a crest width of about 0.076 inch, a root width of about 0.067 inch, and tapered threads 130 conform to thread gauge V-0.076 thread form design data.

### Zinc Phosphate

Tubulars having a box connection 100 and a pin connection 80 known under the trade designation CET®45 may be subject to a surface treatment, such as a zinc phosphate process. The purpose of this process is to ensure tubular 10 or tool joint has the correct structure and thickness, unit weight per area, adheres and imparts the correct lubricity for repeated thread seals and make/breaks under torque without galling. Once both the pin and box are threaded, they are cleaned. The parts must be clean of metal working fluid, grease, oil, rust, paint, and any other contaminant prior to phosphate coating. This can be done using flow over cleaning stations or brush and bucket cleaning using alkaline detergents. Alternative methods include abrasive blasting or wire wheel buffing. After cleaning pin connection 80 and box connection 100 known under the trade designation CET®45, they are rinsed with fresh water to remove any detergent residue. Conversely, any blasting media should be blown out as well to avoid any cross contamination into the zinc phosphate solution. After cleaning and rinsing, the pin connection 80 and box connection 100 known under the trade designation CET®45 are positioned at the application area (rolling rack with an immersion tank containing a suitable zinc phosphate solution, such as the zinc phosphate solution known under the trade designation Solucoat™ 5027J, available from Working Solutions, Inc. Houston, Texas, which is a liquid concentrated zinc phosphate for immersion, spray or flow coat processing of iron, steel, and zinc. The zinc phosphate will impart a tight crystalline coating and can be used as a base for paint, or supplementary oil finish. The operator ensures the zinc phosphate is contained during the coating process. Tubular 10 is elevated at the rear to drain the phosphate back into the heated tank. The operator ensures the application nozzles wet the entire tubular 10 and connections. Any phosphate water break will slow the reaction time down or force the operator to rotate the part for complete saturation. The operator ensures the phosphate solution is not applied using too much pressure. Too much pressure will blow the phosphate solution/coating off before it has a chance to root. Pumps must be sized for high volume flood instead of pressure. If the phosphate splashes back at the operator, the pressure is too high for successful coating. Three things are most important when processing zinc phosphate: phosphate solution concentration, solution temperature, and time. These parameters are altered slightly to adjust for the flow over application technique. Once pin connection 80 and box connection 100 are flow coated in a zinc phosphate solution (20 to 30 min at 175+/−25° F.), the connections are ready for a connection make and break process and final inspection.

### Connection Make and Break

All make and break shall be done after phosphating or other approved surface treatment. The operator removes and cleans the thread protectors since they may be re-used but possibly without any or a different thread compound. The threads and torque shoulder(s) are pre-cleaned, ensuring all oil, dust and other contaminates are removed. The operator pre-inspects threads and shoulders for nicks and burrs. Minor ones can be removed with a deburring tool, file or honing stone. A coating of a thread compound is applied evenly to both the pin and box connection make-up shoulders and threads using a stiff bristle brush to spread and work in a thin uniform coating.

Each of pin connection 80 and box connection 100 known under the trade designation CET®45 are carefully stabbed and made up hand tight to avoiding cross threading or damage to threads and shoulders. The hand tight assembled components are placed in the make and break unit and secured with jaws in the headstock, ensuring the tong jaws are not on any raised hardbanding and are positioned at the center of the tong space and at least 2 inches from box shoulder bearing surface 190/box shoulder stop 200 region so as to avoid crushing or other damage. Avoid positioning the jaws at any location where mill identification markings/stamping will be removed.

Power is then applied to make up a connection between a pin connection 80 and a box connection 100 known under the trade designation CET®45, at a maximum of 60 RPM.

Make and Break three times as follows:
1. Make to 100% of nominal make-up torque (MUT) with specified plus/minus tolerance.
2. Break (monitor breakout torque does not exceed 90% MUT).
3. Make to 100% of nominal MUT with specified plus/minus tolerance.
4. Break (monitor breakout torque does not exceed 90% MUT).
5. Make to 100% of nominal MUT with specified plus/minus tolerance.
6. Break (monitor breakout torque does not exceed 90% MUT).

In the embodiment illustrated schematically, the box diameter is substantially 5.875 inches, the pin inner diameter is 3.25 inches, and the required make-up torque is 42,800 ft-lbs.

The operator then separates the box connection and the pin connection and cleans threads and torque shoulders. An inspection for any pin stretch or box swelling is conducted. If there is any indication of pin stretch or box swelling or both, further quality control (QC) is conducted to dimensional gage the suspect tool joint, including checking box outer diameter, pin length and box depth on double shouldered connections, and the like.

Inspection of threads for galling or other damage is done. Inspection of torque shoulders for pickup or tearing is also performed. The primary shoulders should have a finish of 150 or less and any scratches across the shoulder are not allowed. The secondary torque shoulder is not a seal, it is a mechanical stop. The pin nose must be free of raised metal or other imperfections that could prevent proper make up or cause galling. Pin nose damage can be repaired with a hand file. Tubular 10 is then ready for final inspection.

### Final Inspection

On good connections: the operator cleans threads and torque shoulders properly and thoroughly coated with an environmentally approved (in other words, “Green”) thread storage compound if specified. Heavy duty thread protectors are cleaned and reapplied. “MB” is stamped on the tapered shoulders of box and pin using ¼-inch low stress stamps. The operator then lightly grinds the raised tong marks flush to outer diameter of tong space.

On galled or otherwise damaged connections: a non-conformance report (NCR) is created, and a number or other unique inspection serial number is applied to the tong space, marking the type of damage on the tong space with permanent marker. A record of the type of damage versus NCR/serial number is made on an inspection report. Light oil is applied and a clean thread protector is installed to protect the connection until it can be further evaluated or reworked. The non-conforming tubular is placed in a separate location. Inspection reports and completed work orders are turned over to purchasing to complete the process.

### Joint

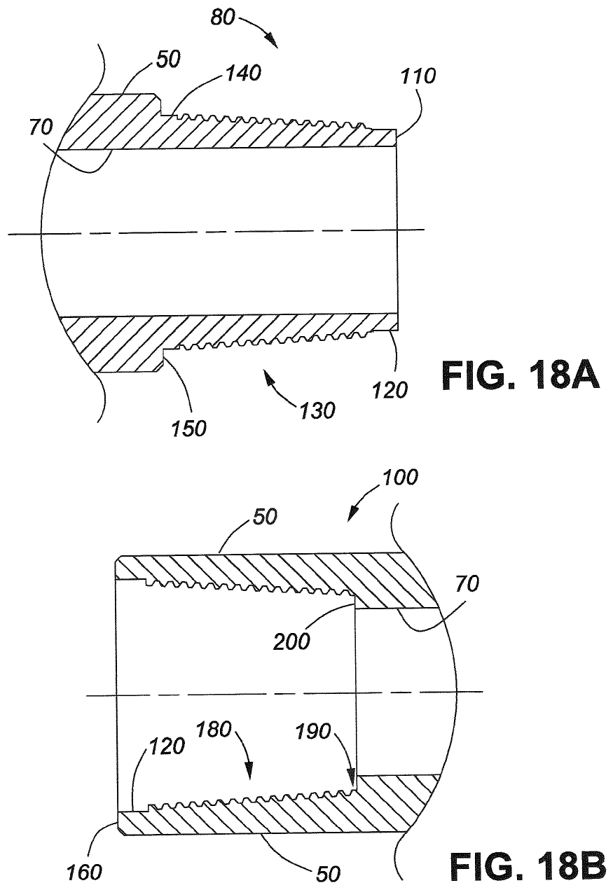

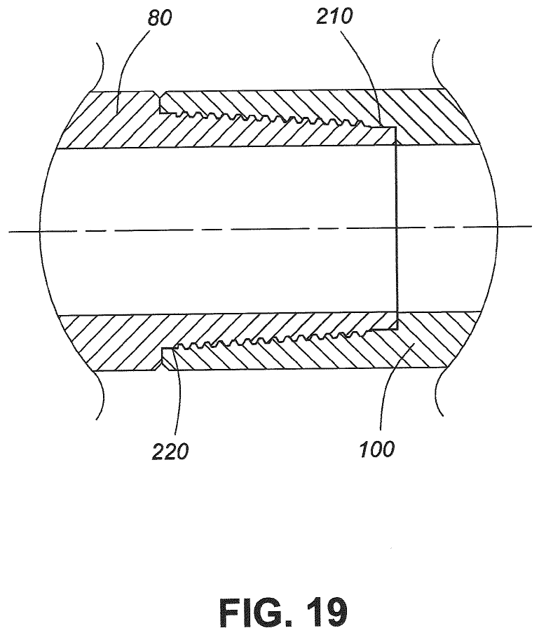

Referring to FIGS. 18A, 18B and 19, pin connection 80 known under the trade designation CET®45 has a nose 110 and a relatively short nose bearing surface 120. A tapered thread 130 extends from the nose bearing surface 130 to a pin shoulder bearing surface 140, and pin connection 80 known under the trade designation CET®45 ends with a pin shoulder stop 150.

Box connection 100 known under the trade designation CET®45 has a face stop 160 and a relatively short face bearing surface 170. A tapered thread 180 extends from the face bearing surface 170 to a box shoulder bearing surface 190, and box connection 100 known under the trade designation CET®45 ends with a box shoulder stop 200.

In the embodiment illustrated schematically, the bearing surfaces may be about ½-inch wide, including nose bearing surface 120 (and mating box shoulder bearing surface 190), pin shoulder bearing surface 140 (and mating face bearing surface 170), or both. If the bearing surface widths do not meet the drawing requirements the mechanical performance of the connections may be compromised, so they would be rejected during final inspection and re-machined to specification.

Referring to FIG. 19, when pin connection 80 and box connection 100 are joined and tightened (for example, torqued), nose bearing surface 120 and mating box shoulder bearing surface 190 are aligned and mated, pin shoulder bearing surface 140 and mating face bearing surface 170 are aligned and mated, nose 110 and box shoulder stop 200 abut, and face stop 160 and pin shoulder stop 150 abut.

In the embodiment illustrated schematically, an annular gap between the bearing surfaces, including annular bearing gap 210 between nose bearing surface 120 and mating box shoulder bearing surface 190, and annular bearing gap 220 between pin shoulder bearing surface 140 and mating face bearing surface 170, or both, are relatively small. In the embodiment illustrated, annular bearing gap 210 or annular bearing gap 220 or both are between about 10 to about 100 thousandths of an inch. In the embodiment illustrated schematically, annular bearing gap 210 or annular bearing gap 220 or both is about 0.020 inches. This relatively small gap allows for transfer of at least a portion of the load/stresses (for example, torque) from box connection 100 to pin connection 80 (or vice-versa) through the bearing surfaces, which lowers the stress on the threads. Pin connection 80 is at least partially restrained or constrained by box connection 100 (in other words, nose bearing surface 120 and pin shoulder bearing surface 140 of pin connection 80 are constrained by the corresponding box shoulder bearing surface 190 and face bearing surface 170 of box connection 100). When rotational torque is applied to tubular 10, the torque is spread among the tapered threads as well as the bearing surfaces. As a result, premium threaded connections known under the trade designation CET®45 can handle more torque than the threads alone could handle.

Recut As known to one skilled in the art, as threads become used or damaged, they may be recut. When recut, the remaining tong space is reduced. Threads known under the trade designation CET®45 permit one or more, recuts, while maintaining a sufficient tong space. In an embodiment disclosed, several recuts may be made, while maintaining a 9 to 12 inch tong space.

FIG. 26 is a logic diagram illustrating one method embodiment of making a premium threaded connection known under the trade designation CET®45 in accordance with the present disclosure (box 300). In one embodiment, the method comprises:
a) providing the tubular, having a non-premium threaded (API or other) box connection and a non-premium threaded pin connection (box 302);
b) heating a hardband portion of the a non-premium threaded box connection to about 950 degrees Fahrenheit and reducing a box outer diameter of the a non-premium threaded box connection (box 304);
c) enlarging a box inner diameter of the a non-premium threaded box connection, wherein a prepared box connection is provided (box 306);
d) applying a box thread to the prepared box connection, wherein the box threads have a pitch of about 0.25 inch (4 TPI), an angle of about 60 degrees, a crest to root height of about 0.092500 inch, a taper of about 1.5 in/ft., a crest width of about 0.076 inch, and a root width of about 0.067 inch (box 308);
e) reducing a pin outer diameter of the a non-premium threaded pin connection (box 310);
f) enlarging an inner diameter of the a non-premium threaded pin connection, wherein a prepared pin connection is provided (box 312); and
g) applying a pin thread to the prepared pin connection, wherein the pin threads have a pitch of about 0.25 inch (4 TPI), an angle of about 60 degrees, a crest to root height of about 0.092504 inch, a taper of about 1.5 in/ft., a crest width of about 0.076 inch, and a root width of about 0.067 inch (box 314).

The premium threaded connections described herein may be applied to non-insulated drill pipe, insulated drill pipe (such as disclosed in our copending U.S. patent application Ser. No. 18/737,363, filed Jun. 7, 2024), heavy walled drill pipe (such as described in our copending U.S. patent application Ser. No. ______, filed) and may be used in onshore and subsea drill strings and risers. The pressure may, in some embodiments, be from about 500 psi to about 15,000 psi or greater; alternatively greater than about 700 psi; alternatively greater than about 800 psi; alternatively greater than about 1,000, or greater than about 2,000 psi, or greater than about 3,000 psi. For example, pressures may range from about 2,000 to about 5,000 psi; or from about 2,500 to about 4,500 psi; or from about 3,000 to about 4,000; or from about 2,500 to about 5,000 psi; or from about 2,000 to about 4,500 psi; or from about 2,000 to about 3,000 psi; or from about 4,000 to about 5,000 psi; or from about 3,000 to about 10,000 psi; or from about 4,000 to about 8,000 psi; or from about 5,000 to about 15,000 psi. All ranges and sub-ranges (including endpoints) between about 500 psi and about 15,000 psi are considered explicitly disclosed herein. The temperature of formations in which the insulated drill pipes may be used may, in some embodiments, be below about 750° F., or below about 700° F., or below about 600° F., or below about 500° F., or below about 400° F.

The drill pipe, inner tubing (in the case of insulated drill pipe), connections, and couplers may be made of metals, except where rubber or other polymeric sealing is employed, such as the rubber and synthetic expansion joints employed in certain insulated drill pipe. Suitable metals include stainless steels, for example, but not limited to, 306, 316, 4145, 4145H, and 4145HT, and the like, as well as titanium alloys, aluminum alloys, and the like. High-strength materials like C-110 and C-125 metallurgies that are NACE qualified may be employed. Use of high strength steel and other high strength materials may significantly reduce the wall thickness required, reducing weight.

Certain components may comprise MONEL, HASTELLOY, titanium, alloy 20, aluminum, or other corrosion-resistant machinable metal. Corrosion-resistant alloys may be preferred in certain sour gas or other service where H2S or acid gases or vapors may be expected, such as T304 stainless steel (or analogs thereof, such as UNS S30400; AMS 5501, 5513, 5560, 5565; ASME SA182, SA194 (8), SA213, SA240; ASTM A167, A182, A193, A194) or T316 stainless steel (or analogs thereof, such as UNS S31600, SS316, 316SS, AISI 316, DIN 1.4401, DIN 1.4408, DIN X5CrNiMo17122, TGL 39672 X5CrNiMo1911, TGL 7143X5CrNiMo1811, ISO 2604-1 F62, ISO 2604-2 TS60, ISO 2604-2 TS61, ISO 2604-4 P60, ISO 2604-4 P61, ISO 4954 X5CrNiMo17122E, ISO 683/13 20, ISO 683/13 20a, ISO 6931 X5CrNiMo17122, JIS SUS 316 stainless steel, or the alloy known under the trade designation MONEL® nickel-copper alloy 400. The composition and some physical properties of MONEL® nickel-copper alloy 400 are summarized in published patents and are also available from Publication Number SMC-053 Copyright® Special Metals Corporation, 2005. The composition and some physical properties of T304 and T316 stainless steels are also published in issued patents. MONEL® nickel-copper alloy 400 (equivalent to UNS N04400/W.Nr.2.4360 and 2.4361) is a solid-solution alloy that can be hardened only by cold working. It has high strength and toughness over a wide temperature range and excellent resistance to many corrosive environments. The skilled artisan, having knowledge of the particular application, pressures, temperatures, and available materials, will be able design the most cost effective, safe, and operable system components for each particular application without undue experimentation.

From the foregoing detailed description of specific embodiments, it should be apparent that patentable premium thread designs, premium threaded connections, drill pipes including pin and box connections including the premium threaded connections, combinations, and processes have been described. Although specific embodiments of the disclosure have been described herein in some detail, this has been done solely for the purposes of describing various features and aspects of the premium thread designs and connections including same, drill pipes, and processes and is not intended to be limiting with respect to their scope. It is contemplated that various substitutions, alterations, and/or modifications, including but not limited to those implementation variations which may have been suggested herein, may be made to the described embodiments without departing from the scope of the appended claims. Some pin and box connections, drill pipes and elements of this disclosure may be devoid of certain components and/or features: for example, pin and box connections and drill pipes devoid of high carbon steel; pin and box connections and drill pipes devoid of low-strength steels.

What is claimed is:

1. A threaded box connection for a first tubular, comprising:
a) a box shoulder stop;
b) a box shoulder bearing surface;
c) a face bearing surface;
d) a face stop;
e) an outer face bevel;
f) box threads extending between the face bearing surface and the box shoulder bearing surface;
g) the threaded box connection adapted to mate with a corresponding threaded pin connection of a second tubular, the box shoulder bearing surface adapted to retain a corresponding nose bearing surface of the threaded pin connection;
h) the box threads are tapered threads having a pitch of about 0.25 inch (4 TPI), a pitch diameter of about 4.896 inches, an angle of about 60 degrees, a crest to root height of about 0.092500 inch, a taper of about 1.5 in/ft., a crest width of about 0.076 inch, a root width of about 0.067 inch, and conform to thread gauge V-0.076 thread form design data;
i) the outer face bevel having bevel diameter of about 5.575 inches (plus or minus 0.016 inch);
j) the face bearing surface having a counterbore diameter of 5.067 inches (plus or minus 0.010 inch); and
k) the box shoulder bearing surface having diameter of about 4.423 inches (plus or minus 0.010 inch).

2. The box connection of claim 1, wherein the face bearing surface is adapted to retain a corresponding pin shoulder bearing surface of a threaded pin connection known under the trade designation CET®45.

3. The box connection of claim 1, wherein the face stop and the pin shoulder stop are adapted to abut, the nose and the box shoulder stop are adapted to abut, or both.

4. The box connection of claim 2, wherein an annular space between the box shoulder bearing surface and the nose bearing surface defines a first bearing gap.

5. The box connection of claim 4, wherein an annular space between the tail bearing surface and the face bearing surface defines a second bearing gap.

6. The box connection of claim 5, wherein the first bearing gap or the second bearing gap or both are in the range of about 0.01 inch to about 0.10 inch.

7. The box connection of claim 6, wherein the first bearing gap or the second bearing gap or both are about 0.020 inch.

8. A tubular comprising the threaded box connection of claim 1.

9. A tubular comprising the threaded box connection of claim 1 at each end of the tubular.

10. A threaded pin connection for a first tubular, comprising:
a) a nose;
b) a nose bearing surface;
c) a pin shoulder bearing surface;
d) a pin shoulder stop;
e) an outer pin shoulder bevel;
f) pin threads extending between the nose bearing surface and the pin shoulder bearing surface;
g) the threaded pin connection adapted to mate with a corresponding threaded box connection of a second tubular, wherein the nose bearing surface is adapted to be retained by a mating box shoulder bearing surface of the threaded box connection;
h) the pin threads are tapered threads having a pitch of about 0.25 inch (4 TPI), an angle of about 60 degrees, a crest to root height of about 0.092504 inch, a taper of about 1.5 in/ft., a crest width of about 0.076 inch, and a root width of about 0.067 inch, and conform to thread gauge V-0.076 thread form design data;
i) the outer pin shoulder bevel having bevel diameter of about 5.575 inches (plus or minus 0.016 inch);
j) the pin shoulder bearing surface having cylinder diameter of about 4.972 inches (plus or minus 0.010 inch); and
k) the nose bearing surface having a diameter of about 4.326 inches (plus or minus 0.010 inch).

11. The pin connection of claim 10, wherein the pin shoulder bearing surface is adapted to be retained by a mating face bearing surface of a threaded box connection known under the trade designation CET®45.

12. The pin connection of claim 10, wherein the face stop and the pin shoulder stop are adapted to abut, the nose and the box shoulder stop are adapted to abut, or both.

13. The pin connection of claim 11, wherein an annular space between the box shoulder bearing surface and the nose bearing surface defines a first bearing gap.

14. The pin connection of claim 11, wherein an annular space between the tail bearing surface and the face bearing surface defines a second bearing gap.

15. The pin connection of claim 14, wherein the first bearing gap or the second bearing gap or both are in the range of about 0.01 inch to about 0.10 inch.

16. The pin connection of claim 10, wherein the first bearing gap or the second bearing gap or both are about 0.020 inch.

17. A tubular comprising at least one of the threaded pin connection of claim 10.

18. A tubular comprising the threaded pin connection of claim 10 at each end of the tubular.

19. A tubular threaded connection comprising:
a) a threaded box connection of a first tubular, comprising:
i) a box shoulder stop;
ii) a box shoulder bearing surface;
iii) a face bearing surface;
iv) a face stop;
v) a face stop bevel; and
vi) box threads extending between the face bearing surface and the box shoulder bearing surface;
b) a threaded pin connection of a second tubular, comprising:
i) a nose;
ii) a nose bearing surface;
iii) a pin shoulder bearing surface;
iv) a pin shoulder stop;
v) an outer pin shoulder bevel;
vi) pin threads extending between the nose bearing surface and the pin shoulder bearing surface;
c) the threaded box connection and the threaded pin connection mate;
d) the box shoulder bearing surface retains the nose bearing surface;
e) the box threads are tapered threads having a pitch of about 0.25 inch (4 TPI), a pitch diameter of about 4.896 inches, an angle of about 60 degrees, a crest to root height of about 0.092500 inch, a taper of about 1.5 in/ft., a crest width of about 0.076 inch, a root width of about 0.067 inch, and conform to thread gauge V-0.076 thread form design data, the box outer face bevel having bevel diameter of about 5.575 inches (plus or minus 0.016 inch), the face bearing surface having a counterbore diameter of 5.067 inches (plus or minus 0.010 inch); and the box shoulder bearing surface having diameter of about 4.423 inches (plus or minus 0.010 inch); and
f) the pin threads are tapered threads having a pitch of about 0.25 inch (4 TPI), an angle of about 60 degrees, a crest to root height of about 0.092504 inch, a taper of about 1.5 in/ft., a crest width of about 0.076 inch, and a root width of about 0.067 inch, and conform to thread gauge V-0.076 thread form design data, the outer pin shoulder bevel having bevel diameter of about 5.575 inches (plus or minus 0.016 inch), the pin shoulder bearing surface having cylinder diameter of about 4.972 inches (plus or minus 0.010 inch), and the nose bearing surface having a diameter of about 4.326 inches (plus or minus 0.010 inch).

20. A method comprising:
a) providing a tubular having an API box connection and an API pin connection;
b) reducing a box outer diameter of the API box connection and enlarging a box inner diameter of the API box connection to provide a prepared box connection;
c) applying a box premium thread to the prepared box connection;
d) reducing a pin outer diameter of the API pin connection and enlarging a pin inner diameter of the API pin connection to provide a prepared pin connection;
e) and applying a pin premium thread to the prepared pin connection, wherein the tubular is provided with a box premium connection and a pin premium connection;
f) the box premium thread comprises tapered threads having a pitch of about 0.25 inch (4 TPI), a pitch diameter of about 4.896 inches, an angle of about 60 degrees, a crest to root height of about 0.092500 inch, a taper of about 1.5 in/ft., a crest width of about 0.076 inch, a root width of about 0.067 inch, and conform to thread gauge V-0.076 thread form design data, the box outer face bevel having bevel diameter of about 5.575 inches (plus or minus 0.016 inch), the face bearing surface having a counterbore diameter of 5.067 inches (plus or minus 0.010 inch); and the box shoulder bearing surface having diameter of about 4.423 inches (plus or minus 0.010 inch);
g) the pin premium thread comprises tapered threads having a pitch of about 0.25 inch (4 TPI), an angle of about 60 degrees, a crest to root height of about 0.092504 inch, a taper of about 1.5 in/ft., a crest width of about 0.076 inch, and a root width of about 0.067 inch, and conform to thread gauge V-0.076 thread form design data, the outer pin shoulder bevel having bevel diameter of about 5.575 inches (plus or minus 0.016 inch), the pin shoulder bearing surface having cylinder diameter of about 4.972 inches (plus or minus 0.010 inch), and the nose bearing surface having a diameter of about 4.326 inches (plus or minus 0.010 inch);
h) retaining a pin shoulder bearing surface of the threaded pin connection with a face bearing surface of the threaded box connection;
i) abutting a face stop of the box connection and a pin shoulder stop of the pin connection, abutting a nose of the pin connection and a box shoulder stop of the box connection, or both;
j) defining a first annular bearing gap between a box shoulder bearing surface of the box connection and a nose bearing surface of the pin connection;
k) defining a second annular bearing gap between a tail bearing surface of the pin connection and a face bearing surface of the box connection;
l) the first bearing gap or the second bearing gap or both are in the range of about 0.01 inch to about 0.10 inch.

21. The method of claim 20, further comprising heating a hardband portion of the API box connection to about 950 degrees Fahrenheit prior to reducing the outer diameter.

22. The method of claim 20, further comprising phosphating the pin and box connections.

23. The method of claim 22, further comprising applying a make and break process to the pin and box connections.

24. The method of claim 20, wherein the connections have an outer diameter of about 5.875 inches and an inner diameter of about 3 inches.

25. The method of claim 20, wherein the tubular is previously used or is reconditioned.

26. The method of claim 20, further comprising performing a wellbore operation using the tubular after applying the premium pin and box threaded connections.

27. The method of claim 26, wherein the wellbore operation comprises drilling or hydraulic fracturing or both.

28. A method of converting a tubular having non-premium threaded connections to premium threaded connections, comprising:
a) providing the tubular, having a non-premium threaded box connection and a non-premium threaded pin connection;
b) heating a hardband portion of the non-premium threaded box connection to about 950 degrees Fahrenheit and reducing a box outer diameter of the non-premium threaded box connection;
c) enlarging a box inner diameter of the non-premium threaded box connection, wherein a prepared box connection is provided;
d) applying a box thread to the prepared box connection, wherein the box threads have a pitch of about 0.25 inch (4 TPI), a pitch diameter of about 4.896 inches, an angle of about 60 degrees, a crest to root height of about 0.092500 inch, a taper of about 1.5 in/ft., a crest width of about 0.076 inch, and a root width of about 0.067 inch, a box outer face bevel having bevel diameter of about 5.575 inches (plus or minus 0.016 inch), a face bearing surface having a counterbore diameter of 5.067 inches (plus or minus 0.010 inch); and a box shoulder bearing surface having diameter of about 4.423 inches (plus or minus 0.010 inch);
e) reducing a pin outer diameter of the non-premium threaded pin connection;
f) enlarging an inner diameter of the pin connection, wherein a prepared pin connection is provided; and
g) applying a pin thread to the prepared pin connection, wherein the pin threads have a pitch of about 0.25 inch (4 TPI), an angle of about 60 degrees, a crest to root height of about 0.092504 inch, a taper of about 1.5 in/ft., a crest width of about 0.076 inch, and a root width of about 0.067 inch, an outer pin shoulder bevel having bevel diameter of about 5.575 inches (plus or minus 0.016 inch), a pin shoulder bearing surface having cylinder diameter of about 4.972 inches (plus or minus 0.010 inch), and a nose bearing surface having a diameter of about 4.326 inches (plus or minus 0.010 inch).

29. The method of claim 28, wherein the connections have an outer diameter of about 5.875 inch and wherein the connections have an inner diameter of about 3 inches.
